(19) United States
(12) Patent Application Publication
(10) Pub. No.: US 2013/0159604 A1
(43) Pub. Date: Jun. 20, 2013

(54) MEMORY STORAGE DEVICE AND MEMORY CONTROLLER AND DATA WRITING METHOD THEREOF

(71) Applicant: Chih-Kang Yeh, Kinmen County (TW)

(72) Inventor: Chih-Kang Yeh, Kinmen County (TW)

(73) Assignee: PHISON ELECTRONICS CORP., Miaoli (TW)

(21) Appl. No.: 13/412,640

(22) Filed: Mar. 6, 2012

(30) Foreign Application Priority Data
Dec. 19, 2011 (TW) 100147011

(51) Int. Cl. G06F 12/00

(52) U.S. Cl. 711/103; 711/E12.008

(57) ABSTRACT

A memory storage device is provided. The memory storage device includes a connector, a rewriteable non-volatile memory module, a second temporary memory and a memory controller having a first temporary memory. The memory controller receives a write command and the write data, and temporarily stores the write data into the first temporary memory. The memory controller also copies the write data into the second temporary memory from the first temporary memory and, based on the write command, writes the write data into the rewriteable non-volatile memory module. Additionally, the memory controller determines whether a program fail occurs when executing the write command. If the program fail occurs, the memory controller reads the write data from the second temporary memory and re-execute the write command. Therefore, a write speed of the memory storage device can be effectively improved.

### CROSS-REFERENCE TO RELATED APPLICATION

This application claims the priority benefit of Taiwan application serial no. 100147011, filed on Dec. 19, 2011. The entirety of the above-mentioned patent application is hereby incorporated by reference herein and made a part of this specification.

### BACKGROUND OF THE INVENTION

1. Technology Field

The present invention relates to a memory storage device, and more particularly, to a memory storage device, a memory controller and a data writing method for effectively improving the data writing speed.

2. Description of Related Art

Along with the widespread of digital cameras, cell phones, and MP3 in recently years, the consumers' demand for storage media has increased drastically. Since a rewritable non-volatile memory has several characteristics such as non-volatility of data, low power consumption, small size, non-mechanical structure, and fast reading and writing speed, the rewritable non-volatile memory is the most suitable memory applied in a portable electronic product, e.g., a laptop. A solid state drive is a memory storage device adopting a flash memory as a storage medium. Therefore, the flash memory industry has become a very popular part of the electronic industry in recent years.

When the data is written into the rewritable volatile memory, a program fail may be occurred in the rewritable volatile memory, and the data writing is unsuccessful. Hence, at least one temporary memory would be disposed within a memory storage device in general. The temporary memory is adopted for temporarily storing the data desired to be written to the memory storage device. In other words, data to be written to the memory storage device is stored in the temporary memory first, and then the data is written to the rewritable volatile memory from the temporary memory. Therefore, for writing data, the writing and reading operations on the temporary memory are both needed. As a result, when the transmission bandwidth of the temporary memory is not large enough, the bandwidth allocated for the data writing is relatively less.

Moreover, when the data is temporarily stored in the temporary memory, a control circuit of the memory storage device sends a signal, which indicates that the command is accomplished, to a host in order to receive the next command and data. When the data is written to the rewritable volatile memory, a program fail may be occurred, and the data writing is unsuccessful. Accordingly, the control circuit of the memory storage device has to write the data stored in the temporary memory into the rewritable volatile memory again (This is also called “a rewrite operation”) where the data writing was failed. As a result, the temporary memory disposed in the memory storage device has to be large enough in capacity to temporarily store the data so as to perform the rewrite operation.

In light of the foregoing descriptions, in order to increase the writing speed, a temporary memory with large bandwidth is required. However, for the requirement of rewriting, a large storage capacity temporary memory is also needed. Regarded to a temporary memory with large bandwidth, the cost of each memory unit is relatively high. Therefore, how to lower the production cost but still keep a temporary memory with appropriate capacity and bandwidth is the most concerned topic for the persons skilled in this art.

Nothing herein should be construed as an admission of knowledge in the prior art of any portion of the present invention. Furthermore, citation or identification of any document in this application is not an admission that such document is available as prior art to the present invention, or that any reference forms a part of the common general knowledge in the art.

### SUMMARY

The present invention is directed to a memory storage device, a memory controller, and a data writing method for effectively improving the data writing speed of the memory storage device.

According to an exemplary embodiment of the present invention, a memory storage device including a connector, a rewritable non-volatile memory module, a memory controller and a second temporary memory is provided. The connector is configured for being coupled to the host system. The memory controller is coupled to the connector and the rewritable non-volatile memory module, and comprises a first temporary memory, wherein the first temporary memory has a temporary write data storage area. The second temporary memory is coupled to the first temporary memory, wherein the transmission bandwidth of the second temporary memory is smaller than the first temporary memory. The memory controller is used for receiving the write data corresponding to the write command, and the write data is temporarily stored in the temporary write data storage area. The memory controller is further configured for copying the write data into the second temporary memory from the temporary write data storage area, and writing the write data into the rewritable non-volatile memory module from the temporary write data storage area according to the write command. Furthermore, the memory controller also determines whether a program fail is occurred after writing the write data into the rewriteable non-volatile memory module. If the program fail is occurred, the memory controller is further configured for reading the write data from the second temporary memory and writing the write data into the rewriteable non-volatile memory module according to the write command.

According to an exemplary embodiment of the present invention, a data writing method for a memory storage device is provided. The memory storage device includes the second temporary memory, the memory controller and the rewriteable non-volatile memory module, wherein a first temporary memory is disposed in the memory controller and the transmission bandwidth of the first temporary memory is larger than the second temporary memory. The data writing method comprises receiving a write command and the write data corresponding to the write command, and temporarily storing the write data in a temporary write data storage area of the first temporary memory. The data writing method also comprises copying the write data into the second temporary memory from the temporary write data storage area as well as writing the write data into the rewritable non-volatile memory module from the temporary write data storage area according to the write command. The data writing method further comprises determining whether a program fail is occurred after writing the write data into the rewritable non-volatile memory module, and if the program fail is occurred, then reading the write data from the second temporary memory and writing the write data into the rewritable non-volatile memory module according to the write command.

According to an exemplary embodiment of the present invention, a memory controller for controlling the rewritable non-volatile memory module is provided. The memory controller comprises a host interface, a memory interface, a memory management circuit and a first temporary memory. The host interface is configured to be coupled to a host system. The memory interface is configured to be coupled to the rewritable non-volatile memory module. The memory management circuit is coupled to the host interface and the memory interface. A first temporary memory is coupled to the memory management circuit, and comprises a temporary write data storage area. Wherein, the memory management circuit is configured to receive the write data from the host system corresponding to a write command and temporarily store the write data into the temporary write data storage area. The memory management circuit is configured for writing the write data into the rewritable non-volatile memory module from the temporary write data storage area according to the write command. Furthermore, the memory management circuit is further configured for copying the write data into the second temporary memory from the temporary write data storage area, wherein the transmission bandwidth of the first temporary memory is larger than the transmission bandwidth of the second temporary memory. The memory management circuit is further configured for determining whether a program fail is occurred after writing the write data into the rewritable non-volatile memory module. If the program fail is occurred, the memory management circuit reads the write data from the second temporary memory and writes the write data into the rewritable non-volatile memory module from the temporary write data storage area according to the write command.

In summary, the memory storage device, the data writing method and the memory controller provided in the present invention employ the first temporary memory in the memory controller as a buffer and employ all of the transmission bandwidth of the second temporary memory as the transmission bandwidth for data writing. Therefore, the transmission bandwidth of the second temporary memory can be efficiently applied for improving the writing speed of the memory storage device.

In order to make the aforementioned and other features and advantages of the invention more comprehensible, embodiments accompanying figures are described in detail below.

It should be understood, however, that this Summary may not contain all of the aspects and embodiments of the present invention, is not meant to be limiting or restrictive in any manner, and that the invention as disclosed herein is and will be understood by those of ordinary skill in the art to encompass obvious improvements and modifications thereto.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a diagram of a host system and a memory storage device according to an exemplary embodiment of the present invention.

FIG. 1B is a diagram of a computer, an input/output device, and a memory storage device according to an exemplary embodiment of the present invention.

FIG. 1C is a diagram of a host system and a memory storage device according to an exemplary embodiment of the present invention.

FIG. 2 illustrates a schematic block diagram of the memory storage device illustrating in FIG. 1A.

FIG. 3 illustrates a schematic block diagram of a memory controller according to an exemplary embodiment of the present invention.

FIG. 4 illustrates a diagram of writing data according to an exemplary embodiment of the present invention.

FIG. 5 illustrates a flowchart of a data writing method according to an exemplary embodiment of the present invention.

### DESCRIPTION OF EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Embodiments of the present invention may comprise any one or more of the novel features described herein, including in the Detailed Description, and/or shown in the drawings. As used herein, “at least one”, “one or more”, and “and/or” are open-ended expressions that are both conjunctive and disjunctive in operation. For example, each of the expressions “at least on of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

It is to be noted that the term “a” or “an” entity refers to one or more of that entity. As such, the terms “a” (or “an”), “one or more” and “at least one” can be used interchangeably herein.

Generally speaking, a memory storage device (or a memory storage system) comprises a rewritable non-volatile memory module and a controller (or a control circuit). The memory storage device is usually used together with a host system so that the host system can write data into or read data from the memory storage device.

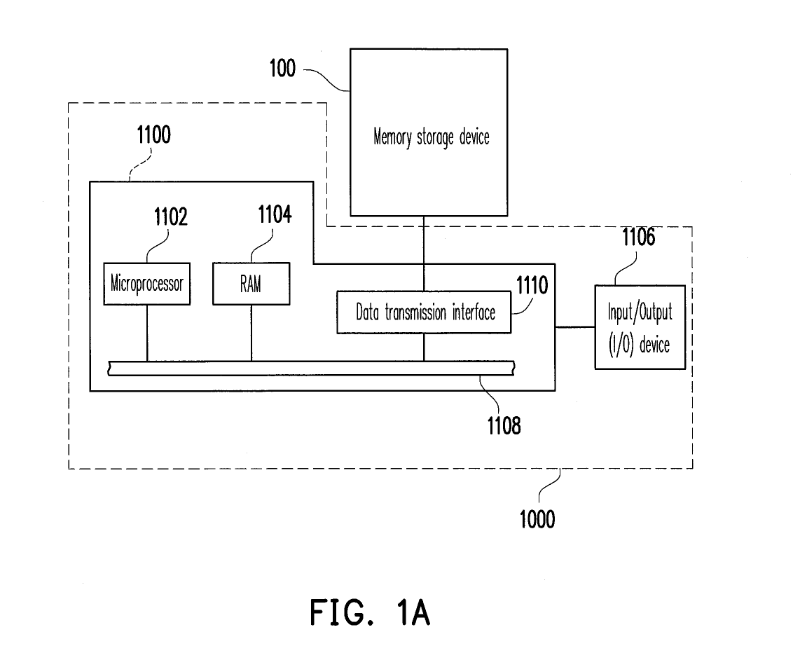

FIG. 1A is a diagram of a host system and a memory storage device according to an exemplary embodiment of the present invention.

Referring to FIG. 1A, a host system 1000 includes a computer 1100 and an input/output (I/O) device 1106. The computer 1100 includes a microprocessor 1102, a random access memory (RAM) 1104, a system bus 1108, and a data transmission interface 1110. For example, the I/O device 1106 includes a mouse 1202, a keyboard 1204, a display 1206 and a printer 1208 as shown in FIG. 1B. It should be understood that the devices illustrated in FIG. 1B are not intended to limit the I/O device 1106, and the I/O device 1106 may further include other devices.

In the present exemplary embodiment, the memory storage device 100 is coupled to other elements of the host system 1000 through the data transmission interface 1110. By using the microprocessor 1102, the RAM 1104, and the I/O device 1106, the data can be written into or read from the memory storage apparatus 100. The memory storage device 100 is, for example, a flash drive 1212, a memory card 1214, or a solid state drive (SSD) 1216 which are rewritable non-volatile storage device as shown in FIG. 1B.

Generally speaking, the host system 1000 may be any system which can substantially cooperate with the memory storage device 100 for storing data. Even though the host system 1000 is described as a computer system in the present exemplary embodiment, the host system 1000 in another exemplary embodiment may be a digital camera, a video camera, a communication device, an audio player, a video player, and so forth. For example, if the host system is a digital camera (video camera) 1310, the rewritable non-volatile memory storage device is then a Secure digital (SD) card 1312, a Multi Media Card (MMC) 1314, a memory stick 1316, a compact flash (CF) card 1318 or an embedded storage device 1320 (as shown in FIG. 1C) applied in the host system. The embedded storage device 1320 includes an Embedded MMC (eMMC). It should be mentioned that the eMMC is directly coupled to a substrate of the host system.

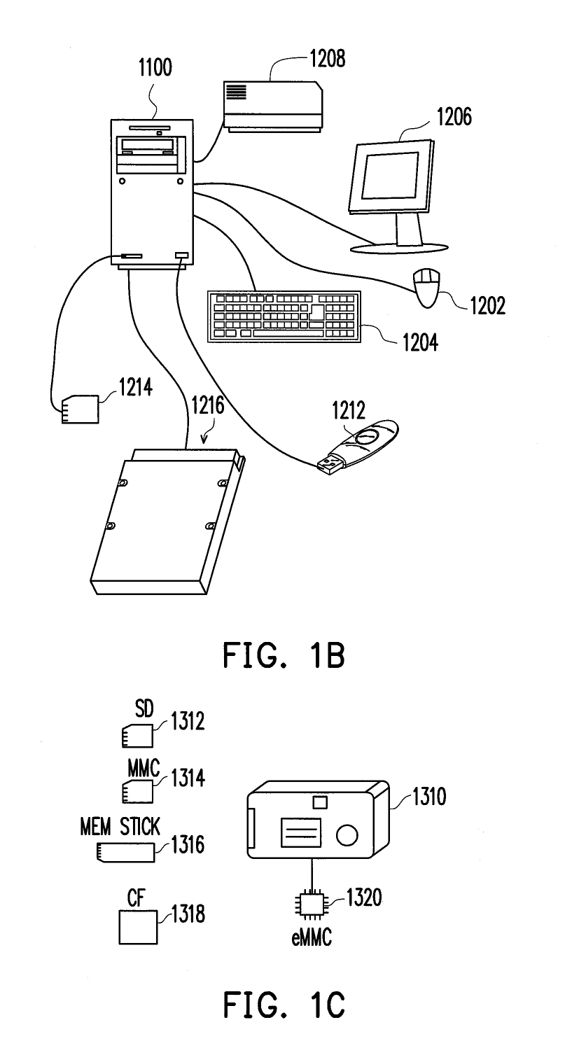

FIG. 2 illustrates a schematic block diagram of the memory storage device illustrating in FIG. 1A.

Referring to the FIG. 2, the memory storage device 100 comprises a connector 102, a memory controller 104, a rewritable non-volatile memory module 106 and a second temporary memory 108.

In the present exemplary embodiment, the connector 102 complies with the serial advanced technology attachment (SATA) standard. However, It should be understood that the present invention is not limited thereto, and the connector 102 may also complies with a Parallel Advanced Technology Attachment (PATA) standard, an Institute of Electrical and Electronic Engineers (IEEE) 1394 standard, a peripheral component interconnect express (PCI Express) standard, a universal serial bus (USB) connector, a secure digital (SD) standard, a memory sick (MS) standard, a multi media card (MMC) standard, a compact flash (CF) standard, an integrated device electronics (IDE) standard, or other suitable standard.

The memory controller 104 executes a plurality of logic gates or control commands which are implemented in a hardware form or in a firmware form as well as performs operations such as writing, reading or erasing the data in the rewritable non-volatile memory module 106 according to the commands of the host system 1000.

The rewritable non-volatile memory module 106 is coupled to the memory controller 104, and is configured to store the data written by the host 1000. The rewritable non-volatile memory module 106 includes several physical blocks (not shown). In the present exemplary embodiment, the rewritable non-volatile memory module 106 is a Multi Level Cell (MLC) NAND flash memory module. However, the present invention is not limited thereto. The rewritable non-volatile memory module 106 can be a Single Level Cell (SLC) NAND flash memory module, other flash memory modules or other memory modules with the same property.

The second temporary memory 108 is disposed outside the memory controller and coupled to the memory controller 108. The second temporary memory 108 is configured for temporarily storing the commands or the data executed by memory controller 104. For example, the second temporary memory is for receiving the writing data from the host system 1000 and preparing a backup. In the present exemplary embodiment, the second temporary memory 108 is a synchronous dynamic random access memory (SDRAM) and the transmission bandwidth of the second temporary memory 108 is 400M bits/sec. However, the present invention is not limited thereto. The second temporary memory 108 may be a dynamic random access memory (DRAM), a static random access memory (SRAM), a magnetoresistive random access memory (MRAM), a cache random access memory (Cache RAM), a synchronous dynamic random access memory (SDRAM), video random access memory (VRAM), NOR flash memory (NOR flash), embedded dynamic random access memory (eDRAM) or other memories.

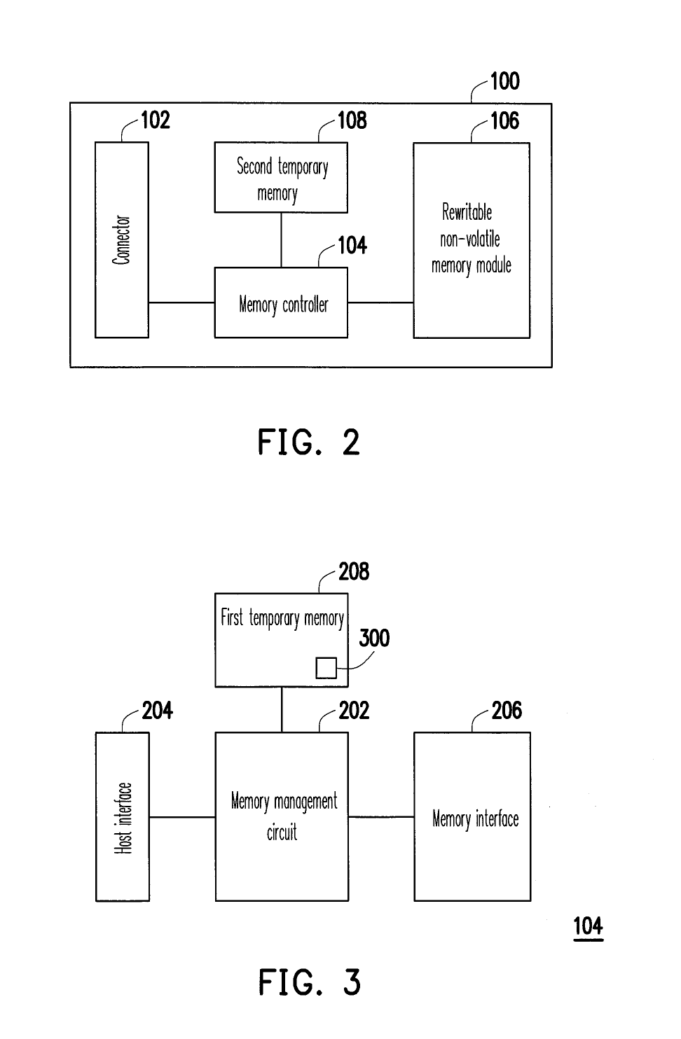

FIG. 3 illustrates a schematic block diagram of a memory controller according to an exemplary embodiment of the present invention.

Referring to the FIG. 3, the memory controller 104 comprises a memory management circuit 202, a host interface 204, a memory interface 206 and a first temporary memory 208.

The memory management circuit 202 is configured to control the whole operation of the memory controller 104. To be more specific, the memory management circuit 202 includes a plurality of the control commands which are executed for data writing, reading and erasing when the memory storage device 100 is operated.

In the present exemplary embodiment, the control instructions of the memory management circuit 202 are implemented in a firmware form. For instance, the memory management circuit 202 includes a micro-processor unit (not shown) and a read-only memory (not shown), and these control commands are burned into the read-only memory. When the memory storage apparatus 100 is enabled, the control instructions are executed by the micro-processor unit to write, read, and erase data.

In another exemplary embodiment of the invention, the control instructions of the memory management circuit 202 are stored in a specific area (for instance, the system area of the memory module exclusively used for storing system data) of the rewritable non-volatile memory module 106 as program codes. Additionally, the memory management circuit 202 may have a micro-processor unit (not shown), a read-only memory (not shown), and a RAM (not shown). Particularly, the read-only memory has a boot code, and when the memory controller 104 is enabled, the micro-processor unit executes the boot code to load the control instructions of the memory management circuit 202 stored in the rewritable non-volatile memory module 106 into the RAM of the memory management circuit 202. The micro-processor unit then executes the control instructions to write, read, and erase data.

Furthermore, in another exemplary embodiment of the present invention, the control commands of the memory management circuit 202 can be implemented in a hardware form. For example, the memory management circuit 202 includes a micro control unit, a memory managing unit, a memory writing unit, a memory reading unit, a memory erasing unit and a data processing unit. The memory managing unit, the memory writing unit, the memory reading unit, the memory erasing unit and the data processing unit are coupled to the micro control unit. Wherein, the memory managing unit is for managing the physical blocks of the rewritable non-volatile memory module 106, the memory writing unit is configured for issuing write commands to the rewritable non-volatile memory module 106 to write data into the rewritable non-volatile memory module 106, the memory reading unit is configured for issuing read commands to the rewritable non-volatile memory module 106 to read the data from the rewritable non-volatile memory module 106, the memory erasing unit is for issuing the erase command to the rewritable non-volatile memory module 106 to erase the data in the rewritable non-volatile memory module 106, and the data processing unit is configured for processing the data to be write into the rewritable non-volatile memory module 106 or data read from the rewritable non-volatile memory module 106.

The host interface 204 is coupled to the memory management circuit 202 and configured to receive and identify the commands and the data transmitted by the host system 1000. Namely, the commands and the data transmitted by the host system 1000 are passed to the memory management circuit 202 through the host interface 204. In the present exemplary embodiment, the host interface 204 complies with the SATA standard. However, the present invention is not limited thereto, and the host interface 204 may also be compatible with a PATA standard, IEEE 1394 standard, a PCI Express standard, a USB standard, a SD standard, a MS standard, a MMC standard, a CF standard, an IDE standard, or other suitable types of data transmission standards.

The memory interface 206 is coupled to the memory management circuit 202 for accessing the rewritable non-volatile memory module 106. In other words, the data desired to be written to the rewritable non-volatile memory module 106 is converted to an acceptable format for the rewritable non-volatile memory module 106 by the memory interface 206.

The first temporary memory 208 is coupled to the memory management circuit 202 for temporarily storing the commands executed by memory management circuit 202 or the data. To be more specific, the first temporary memory 208 comprises a temporary write data storage area 300 which is for temporarily storing the data written by the host system 1000. However, it should be understood that, except the temporary write data storage area, the first temporary memory 208 further comprises other areas (not shown) for temporarily storing other data. For example, the memory management circuit 202 may store a mapping table of virtual addresses and physical addresses of the rewritable non-volatile memory module 106 in other areas of the first temporary memory 208. In the present exemplary embodiment, the transmission bandwidth of the first temporary memory 208 is larger than the transmission bandwidth of the second temporary memory 108. For example, the first temporary memory 208 is a static random access memory (SRAM). However, the first temporary memory 208 can be the MRAM, Cache RAM, SDRAM, VRAM, NOR Flash or eDRAM. Herein, the transmission bandwidth of the first temporary memory 208 is 800M bits/sec.

In the present exemplary embodiment, in order to improve the data writing speed of the memory storage device 100, the first temporary memory 208 with the larger transmission bandwidth is configured as a region for temporarily storing write data and the second temporary memory 108 with smaller transmission bandwidth is configured as a backup region for storing the write data.

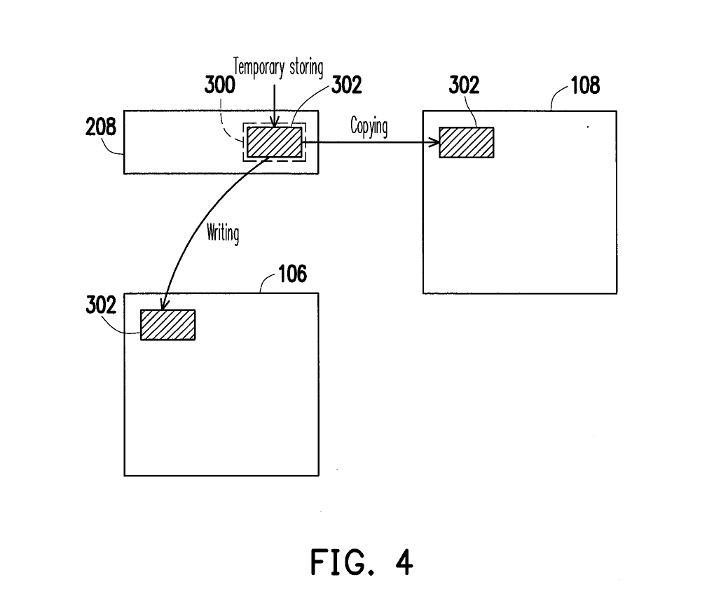

FIG. 4 illustrates a diagram of writing data according to an exemplary embodiment of the present invention.

Referring to the FIG. 4, when the memory storage device 100 receives a write command and the write data 302 corresponding to the write command from the host system 1000, the memory management circuit 202 stores the write data 302 to the temporary write data storage area 300. Since the first temporary memory 208 has a larger transmission bandwidth, the first temporary memory 208 can satisfy the requirement of the host system 1000 for data writing. In other words, the writing speed of the memory management circuit 202 temporarily storing the write data 302 into the temporary write data storage area 300 is not slower than the writing speed of the host system 1000 transmitting the write data 302 to the memory management circuit 202. Therefore, it is possible to receive data from the host system 1000 in real time and temporarily store the data into the first temporary memory 208 is capable.

In the present exemplary embodiment, the transmission bandwidth of the first temporary memory 208 can be shared by at least two operations, for example, a write operation or a read operation. For example, while data is written into the first temporary memory 208, another data may be read from the first temporary memory 208 and transmitted to the rewritable non-volatile memory module 106. For another example, while data is written into the first temporary memory 208, another data may be read from the first temporary memory 208 and transmitted to the second temporary memory 108.

Next, the memory management circuit 202 reads the write data 302 from the temporary write data storage area 300, and writes the write data 302 into the rewritable non-volatile memory module 106 according to the above-mentioned write command.

On the other hand, the memory management circuit 202 reads the write data 302 from the temporary write data storage area 300 and copies the write data 302 to the second temporary memory 108. It should be noted that, in the present exemplary embodiment, the transmission bandwidth of the second temporary memory 108 can be fully used for transmitting the write data 302. In other words, for the write data 302, the memory management circuit 202 can only perform the write operation to the second temporary memory 108 without any read operation. In addition, the memory management circuit 202 can simultaneously write the write data 302 to the rewritable non-volatile memory module 106 and copy the write data 302 to the second temporary memory 108, too.

Accordingly, the write data 302 is stored in the second temporary memory 108, and the memory controller 104 temporarily stores the following write data into the first temporary memory 208 according to the following write command from the host system 1000. Especially, since the write data 302 is already stored in the second temporary memory 108, the address for storing the write data 302 in the first temporary memory 208 may be used for temporarily storing another new write data without interfering the operation of the memory storage device 100.

To be more specific, the memory management circuit 202 determines whether a program fail is occurred after writing the write data 302 into the rewritable non-volatile memory module 106. If the program fail is occurred, the memory management circuit 202 reads the write data 302 from the second temporary memory 108 and writes the write data 302 into the rewritable non-volatile memory module 106 again according to the write command. In other words, when the program fail is occurred and the write data 302 is failed to be written into the rewritable non-volatile memory module 106, even the write data 302 in the first temporary memory 208 has been updated to another new write data, the write data 302 still can be found in the second temporary memory 108 and be written into the rewritable non-volatile memory module 106 by the memory management circuit 202. As a result, the memory storage device 100 uses the first temporary memory 208 with larger bandwidth to increase the writing speed, so as to make sure the write data 302 can be written in the rewritable non-volatile memory module 106 successfully. In the present exemplary embodiment, when the memory management circuit 202 reads the write data 302 from the second temporary memory 108, the transmission bandwidth of the second temporary memory 108 can be fully used for transmitting the write data 302. In addition, in the present exemplary embodiment, the transmission bandwidth of the second temporary memory 108 can be used to execute only a single process, for example, a write process or a read process. For example, the transmission bandwidth of the second temporary memory 108 can be fully used for receiving the data into the second temporary memory 108. Or, the transmission bandwidth of the second temporary memory 108 can be fully used for outputting the data from the second temporary memory 108.

Moreover, in the present exemplary embodiment, the memory management circuit 202 is used for receiving a read command from the host system 1000. Especially, after receiving the read command, the memory management circuit 202 determines whether the second temporary memory 108 has the read data corresponding to the read command. If the second temporary memory 108 has the read data corresponding to the read command, the memory management circuit 202 reads the read data corresponding to the read command from the second temporary memory 108 and transmits the read data to the host system 1000 in response to the read command received by the memory management circuit 202. For example, the host system 1000 writes the write data 302 into the memory storage device 100, and after a time period, reads the write data 302 from the memory storage device 100. Since the memory management circuit writes the write data 302 into the second temporary memory 108 as the backup when writing the write data 302 into the rewritable non-volatile memory module 106, the write data may still be stored in the second temporary memory 108 and the rewritable non-volatile memory module 106 when the host system 1000 reads the write data 302 from the memory storage device 100. Therefore, if the data corresponding to the read command is still stored in the second temporary memory 108, time for reading data can be shortened by transmitting the corresponding data to the host system 1000 from the second temporary memory 108.

In the present exemplary embodiment, the capacity of the first temporary memory 208 is smaller than the capacity of the second temporary memory 108. For example, the capacity of the second memory 108 is 8 times the capacity of the first temporary memory 208, and the second temporary memory 108 and the first temporary memory 208 have better using efficiency. To be more specific, for example, if the capacity of the second temporary space 108 is smaller than 8 times the capacity of the first temporary memory 208, when the temporary write data storage area 300 is full of the data and the memory management circuit 202 tries to write the write data stored in the temporary write data storage area 300 into the second temporary memory 108 as a backup, the capacity of the second temporary memory 108 may be insufficient for the write data as the backup. On the other hand, if the capacity of the second temporary memory 108 is greater than 8 times the capacity of the first temporary memory, although the above-mentioned insufficient capacity problem of the second temporary memory is no longer existed, the second temporary memory may contain too much unused memory space, or the backup data is too old which leads the host system 1000 does not read the data often and causes the low using efficiency of the second temporary memory. Hence, when the capacity of the second temporary memory 108 is 8 times the capacity of the first temporary memory 208, the memory using efficiency is much better. However, the ratio relationship of the capacity is obtained from experience, so it can be changed to 4 times, 10 times or other ratios based on the actual case.

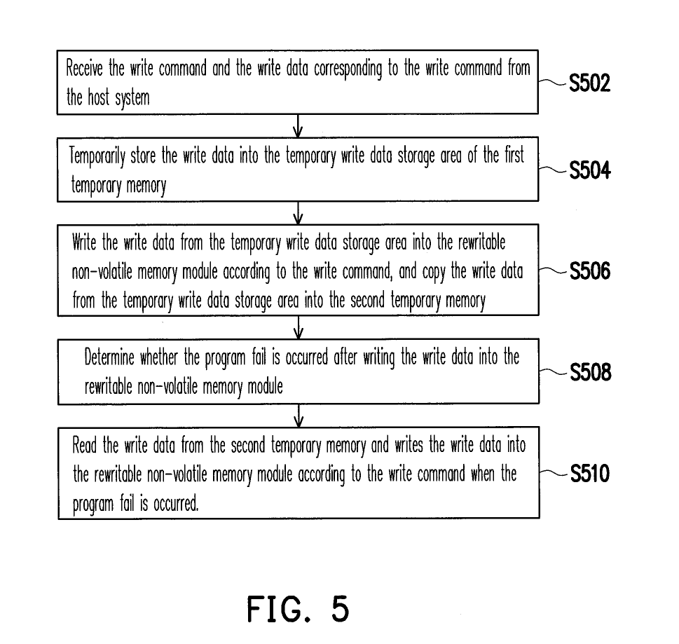

FIG. 5 illustrates a flowchart of a data writing method according to an exemplary embodiment of the present invention.

Referring to the FIG. 5, in the step S502, the memory management circuit 202 of the memory controller 104 receives a write command and the write data corresponding to the write command from the host system. Then, in step S504, the memory management circuit 202 temporarily stores the write data into the temporary write data storage area of the first temporary memory.

Moreover, in the step S506, the memory management circuit 202 writes the write data from the temporary write data storage area into the rewritable non-volatile memory module according to the write command, and copies the write data from the temporary write data storage area into the second temporary memory.

Next, in the step S508, the memory management circuit 202 determines whether a program fail is occurred after writing the write data into the rewritable non-volatile memory module. If the program fail is occurred, in the step S510, the memory management circuit reads the write data from the second temporary memory and writes the write data into the rewritable non-volatile memory module from the temporary write data storage area again according to the write command.

However, the above-mentioned steps of the data writing method may have different orders and not limited as the order in the invention of the FIG. 5

It should be noted that, although in the present exemplary embodiment of the invention, the second temporary memory 108 is disposed outside the memory controller 104. However, the present invention is not limited and the second temporary memory can be disposed inside of the memory controller 104.

In summary, the memory storage device, the memory controller and the writing method provided by the present embodiment can apply the transmission bandwidth of a temporary memory in the memory storage device in a more efficiency way. In other words, during the data writing, the transmission bandwidth of the temporary memory for write data backup is fully applied for transmitting the write data. Accordingly, the writing speed of the memory storage device is increased. The previously described exemplary embodiments of the present invention have the advantages aforementioned, wherein the advantages aforementioned not required in all versions of the invention.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A memory storage device, comprising:
a connector, configured to be coupled with a host system;
a rewritable non-volatile memory module;
a memory controller, coupled to the connector and the rewritable non-volatile memory module, wherein the memory controller includes a first temporary memory having a temporary write data storage area; and
a second temporary memory, coupled to the first temporary memory, wherein a transmission bandwidth of the second temporary memory is smaller than a transmission bandwidth of the first temporary memory,
wherein the memory controller is configured to receive at least one write data corresponding to at least one write command and to temporarily store the at least one write data into the temporary write data storage area,
wherein the memory controller is further configured to write the at least one write data into the rewritable non-volatile memory module from the temporary write data storage area according to the at least one write command,
wherein the memory controller is further configured to copy the at least one write data into the second temporary memory from the temporary write data storage area according to the at least one write command,
wherein the memory controller is further configured to determine whether a program fail is occurred after writing the at least one write data into the rewritable non-volatile memory module,
wherein when the program fail is occurred, the memory controller is further configured to read the at least one write data from the second temporary memory and write the at least one write data into the rewritable non-volatile memory module according to the at least one write command.

2. The memory storage device according to claim 1,
wherein the memory controller is further configured to receive at least one read command from the host system,
wherein the memory controller is further configured to determine whether at least one read data corresponding to the at least one read command is stored in the second temporary memory,
if the at least one read data corresponding to the at least one read command is stored in the second temporary memory, the memory controller reads the at least one read data form the second temporary memory and transmits the at least one read data to the host system in respond to the at least one read command.

3. The memory storage device according to claim 1, wherein the second temporary memory is disposed in the memory controller or outside the memory controller.

4. The memory storage device according to claim 1, wherein the first temporary memory is a static random access memory (SRAM).

5. The memory storage device according to claim 1, wherein the second temporary memory is a synchronous dynamic random access memory (SDRAM).

6. The memory storage device according to claim 1, wherein a capacity of the second temporary memory is larger than a capacity of the first temporary memory.

7. The memory storage device according to claim 6, wherein the capacity of the second temporary memory is 8 times the capacity of the first temporary memory.

8. The memory storage device according to claim 1, wherein the transmission bandwidth of the second temporary memory is applied in a single process and the transmission bandwidth of the first memory is shared in a plurality of the processes.

9. A data writing method, for a memory storage device, wherein the memory storage device comprises a second temporary memory, a memory controller and a rewritable non-volatile memory module, a first temporary memory is disposed in the memory controller and a transmission bandwidth the first temporary memory is larger than a transmission bandwidth of the second temporary memory, the data writing method comprises:
receiving at least one write command and at least one write data corresponding to the at least one write command from the host system;
storing the at least one write data into a temporary write data storage area in the first temporary memory temporarily;
writing the at least one write data corresponding to the at least one write command into the rewritable non-volatile memory module from the temporary write data storage area;
copying the at least one write data into the second temporary memory from the temporary write data storage area;
determining whether a program fail is occurred after writing the at least one write data into the rewritable non-volatile memory module; and
reading the at least one write data from the second temporary memory and writing the at least one write data into the rewritable non-volatile memory module according to the at least one write command when the program failed is occurred.

10. The data writing method according to claim 9 further comprising:
receiving at least one read command from the host system;
determining whether at least one read data corresponding to the at least one read command is stored in the second temporary memory; and
reading the at least one read data from the second temporary memory and transmitting the at least one reading data to the host system in response to the read command when the at least one read data corresponding to the at least one read command is stored in the second temporary memory.

11. A memory controller, controlling a rewritable non-volatile memory module, wherein the memory controller comprising
a host interface, coupled to a host system;
a memory interface, coupled to the rewritable non-volatile memory module;
a memory management circuit, coupled to the host interface and the memory interface; and
a first temporary memory, coupled to the memory management circuit, comprising a temporary write data storage area,
wherein the memory management circuit is configured to receive at least one write data corresponding to at least one write command from the host system and to temporarily store the at least one write data into the temporary write data storage area,
wherein the memory management circuit is further configured to write the at least one write data into the rewritable non-volatile memory module from the temporary write data storage area according to the at least one write command,
wherein the memory management circuit is further configured to copy the at least one write data into the second temporary memory from the temporary write data storage area, wherein a transmission bandwidth of the first temporary memory is larger than a transmission bandwidth of the second temporary memory,
wherein the memory management circuit is further configured to determine whether a program fail is occurred after writing the at least one write data into the rewritable non-volatile memory module,
wherein when the program fail is occurred, the memory controller is configured to read the at least one write data from the second temporary memory and to write the at least one write data into the rewritable non-volatile memory module according to the at least one write command.

12. The memory controller according to claim 11,
wherein the memory management circuit is further configured to receive at least one read command form the host system,
wherein the memory management circuit is further configured to determine whether at least one read data corresponding to the at least one read command is stored in the second temporary memory,
if the at least one read data corresponding to the at least one read command is stored in the second temporary memory, the memory management circuit reads the at least one read data form the second temporary memory and transmits the at least one read data to the host system in respond to the at least one read command.

13. The memory controller according to claim 11, wherein the second temporary memory is disposed in the memory controller or outside the memory controller.

14. The memory controller according to claim 11, wherein the first temporary memory is a static random access memory (SRAM).

15. The memory controller according to claim 11, wherein the second temporary memory is a synchronous dynamic random access memory (SDRAM).

16. The memory controller according to claim 11, wherein a capacity of the second temporary memory is larger than a capacity of the first temporary memory.

17. The memory controller according to claim 16, wherein the capacity of the second temporary memory is 8 times the capacity of the first temporary memory.
